(19) United States
(12) Patent Application Publication
(10) Pub. No.: US 2025/0180628 A1
(43) Pub. Date: Jun. 5, 2025

(54) Methods for Verifying Integrity and Authenticity of a Printed Circuit Board

(71) Applicant: Worcester Polytechnic Institute, Worcester, MA (US)

(72) Inventors: Tahoura Mosavirik, Worcester, MA (US); Fatemeh Ganji, Northborough, MA (US); Patrick Schaumont, Worcester, MA (US); Shahin Tajik, Northborough, MA (US); Paul L. Martyak Jr., Matthews, NC (US); Michael Thow, Concord, NC (US)

(21) Appl. No.: 18/837,093

(22) PCT Filed: Feb. 9, 2023
(86) PCT No.: PCT/US2023/012704

§ 371 Date: Aug. 8, 2024

Related U.S. Application Data
(60) Provisional application No. 63/309,983, filed on Feb. 14, 2022.

(51) Int. Cl. G01R 31/28; G01R 23/16; G06F 21/73

(52) U.S. Cl. CPC G01R 31/2815; G01R 23/16; G06F 21/73

(57) ABSTRACT

The present invention is directed to a method for verifying the integrity and authenticity of a printed circuit board, including associated components and packaging. The method is based on analyzing the power integrity of the power distribution network of the printed circuit board by measuring the S-parameter for the printed circuit board. Any tampering or counterfeiting can be determined by comparison of the S-parameter data or signature to a known authentic signature.

### BACKGROUND OF THE INVENTION

### Field of the Invention

The invention, including its various embodiments, relates to methods for verifying whether a device under test, such as a printed circuit board including associated components on the PCB and packaging, is authentic or counterfeit or has been subjected to tampering. In particular, the invention, including its various embodiments, relates to methods for characterizing the power distribution network of a printed circuit board for comparison to determine whether the printed circuit board is authentic or has been subjected to tampering.

### Description of Related Art

The globalization of electronic system's manufacturing has been on the rise due to the high demand for reduced fabrication costs and shortened time-to-market. As a result, different steps of design, fabrication, and packaging may no longer be completed at the same location. With many global entities involved in the supply chain, original intellectual property owners and designers no longer have control over the manufacturing and assembly of such systems. The lack of control over the supply chain leaves some critical systems vulnerable to an array of attacks that can occur during various steps in the overall manufacturing and distribution and packaging process prior to deployment.

Such attacks may include tampering with electronic printed circuit boards (PCBs), for example, by implanting malicious computer chips or spy chips or hardware Trojans for eavesdropping on processed/communicated data, obtaining backdoor-access to privileged modes of the system, or providing a kill switch. To perform such attacks, the design may be tampered with before or after board manufacturing. Tampering activities can include drilling the PCB (adding via to the PCB), adding/removing open/short circuits, refurbishing the PCB or its components, cutting traces on the PCB's PDN, and adding/removing components from the PCB.

Similarly, the introduction of counterfeit, recycled, lower quality, or aged components into the supply chain can lead to quality and performance degradation of electronic systems, such as short or open circuits.

As embedded electronics continue to be utilized within numerous systems ranging from smartphones to autonomous vehicles and critical infrastructure, the possibility of attacks or introduction of counterfeit components, for example, can lead to significant financial loss and in some applications (e.g., medical devices) serious human injuries and even fatalities.

Existing techniques that are generally used today for validating hardware are not sufficient to mitigate more advanced cybersecurity threats, such as the recent concerns about hardware trojans and malicious hardware components being embedded within electronic equipment during the manufacturing process. Most techniques in use today are visually based or rely on proprietary solutions that cannot be validated by the end user. This results in relying on the vendor/supplier to guarantee and validate that their product is genuine and has not been tampered with or compromised.

Accordingly, there is a need for an effective method to verify the integrity and authenticity of PCBs (including components, such as capacitors, PCB traces, PCB vias, etc.) down to the IC package level both prior to installation as well as during runtime deployment.

### BRIEF SUMMARY OF THE INVENTION

In general, the present invention is directed to a unified physical verification framework or methods for verifying the integrity and authenticity of PCBs, including associated components on the PCB and packaging. The framework or methods are based on analyzing the power integrity of the power distribution network (PDN) of the PCB whose overall characteristics are determined by the electrical impedance of individual components on the PCB. Any tampering or counterfeiting on the PCB will lead to changes in the equivalent impedance of the PDN or the PDN characteristics over frequency. Accordingly, the physical scanning or monitoring of the PDN will reveal whether the PCB's integrity has been violated, such as through tampering or the use of counterfeit components.

In one embodiment, the method of the present invention is a method for verifying whether a printed circuit board is authentic, comprising characterizing a power distribution network of the printed circuit board to produce a signature based upon a reflection response parameter and comparing the signature from the characterizing to a known signature based upon a reflection response parameter for a corresponding authentic printed circuit board to identify differences. In some embodiments, the reflection response parameter comprises the S-parameter or S₁₁ data, including amplitude (|S₁₁|) and phase (∠S₁₁). In some embodiments, the S₁₁ data is mathematically modeling to provide a modeled set of data for comparison.

Based on the methods of the present invention, the power distribution network of a device-under-test, such as such as a printed circuit board including associated components on the PCB and packaging, can be characterized by measuring the S-parameter and comparing that data or signature to a known signature to determine whether the device-under-test is authenticate or has been subject to tampering or counterfeiting.

### BRIEF DESCRIPTION OF THE SEVERAL VIEWS OF THE DRAWINGS

FIG. 1 illustrates a setup for characterizing a PDN according to one embodiment of the present invention;

FIG. 2 illustrates the method for identifying tampered or counterfeit devices according to one embodiment of the present invention;

FIG. 3A shows the Yokogawa EJX110A differential pressure transmitters;

FIG. 3B illustrates a rear view of the transmitters of FIG. 3A;

FIGS. 4A-D illustrate the results of testing of the Yokogawa EJX110A differential pressure transmitters of FIG. 3A;

FIGS. 5A-B illustrate the Texas Instruments LP-MSP430FR2476 development kit and corresponding schematic;

FIGS. 5C-D illustrate the Texas Instruments MSP-EXP432P401R development kit and corresponding schematic;

FIGS. 6A and 6B illustrate the results of S₁₁ measurements on 10 MSP430FR2476 development kits;

FIGS. 7A and 7B illustrate six different tampering attacks on seven MSP430FR2476 development kits and the resulting S₁₁ measurements in the bandwidth of 100 kHz to 1 GHz;

FIG. 8 shows the backside of two different groups of MSP430FR2476 boards;

FIGS. 9A and 9B illustrate the results of S-parameter measurements for the two different groups of MSP430FR2476 boards;

FIGS. 10A and 10B illustrate the results of the S₁₁ measurements on 12 Texas Instruments MSP432P401R development kits;

FIG. 11A illustrates the results of the S₁₁ measurements on 12 Texas Instruments MSP432P401R development kits in the bandwidth of 100 kHz to 200 MHz based upon gradual removal of electrical components;

FIG. 11B illustrates the clustering results of the S₁₁ measurements on 12 Texas Instruments MSP432P401R development kits in the bandwidth of 100 kHz to 200 MHz based upon various tampering levels;

FIG. 12A illustrates the results of the S₁₁ measurements on 12 Texas Instruments MSP432P401R development kits in the bandwidth of 100 kHz to 1 GHz based upon gradual removal of electrical components;

FIG. 12B illustrates the clustering results of the S₁₁ measurements on 12 Texas Instruments MSP432P401R development kits in the bandwidth of 100 kHz to 1 GHz based upon various tampering levels;

FIGS. 13A and 13B illustrate the detection accuracy for labeled PCBs;

FIGS. 14A and 14B illustrate the clustering results of 12 legitimate boards; and

FIGS. 15A and 15B illustrate the statistical distance for 12 legitimate boards and for legitimate versus tampered boards.

### DETAILED DESCRIPTION OF THE INVENTION

The present invention is more fully described below with reference to the accompanying drawings. While the present invention will be described in conjunction with various embodiments, such should be viewed as examples and should not be viewed as limiting or as setting forth the only embodiments of the invention. Rather, the present invention includes various embodiments or forms, various related aspects or features, and various uses, as well as alternatives, modifications, and equivalents to the foregoing, all of which are included within the spirit and scope of the invention and the claims, whether or not expressly described herein. Further, the use of the terms “invention,” “present invention,” “embodiment,” and similar terms throughout this description are used broadly and are not intended to mean that the invention requires, or is limited to, any particular embodiment or aspect being described or that such description is the only manner in which the invention may be made or used.

In general, the present invention is directed to a unified physical verification framework or method for verifying the integrity and authenticity of PCBs, including associated components on the PCB and packaging. The framework or method is based on analyzing the power integrity of the power distribution network (PDN) of the PCB whose overall characteristics are determined by the electrical impedance of individual components on the PCB.

A power distribution network (PDN) contains the power delivery from the external power regulator all the way down to the transistors on the chip. The PDN is usually modeled as an RLC network. The impedance profile of the RLC network of the PDN is a function of frequency, and the contribution of each individual component to the PDN's impedance is distinct at different frequencies. For example, while in lower frequencies, the equivalent impedance of the PDN is dominated by the voltage regulator's characteristics, and in higher frequencies, the off-chip and on-chip components are contributing most to the impedance.

Any tampering or counterfeiting on the PCB will lead to changes in the equivalent impedance of the PDN or the PDN characteristics over frequency. Accordingly, the physical scanning or monitoring of the PDN before the boot-up process or before the device is deployed in the field will reveal whether the PCB's integrity has been violated. Such a power integrity-based scanning makes the verification method of the present invention generic and applicable to virtually all electronic boards. Following, the method of the present invention for characterizing or measuring the PDN of a PCB to identify tampering and counterfeiting of the PCB is described in conjunction with the figures.

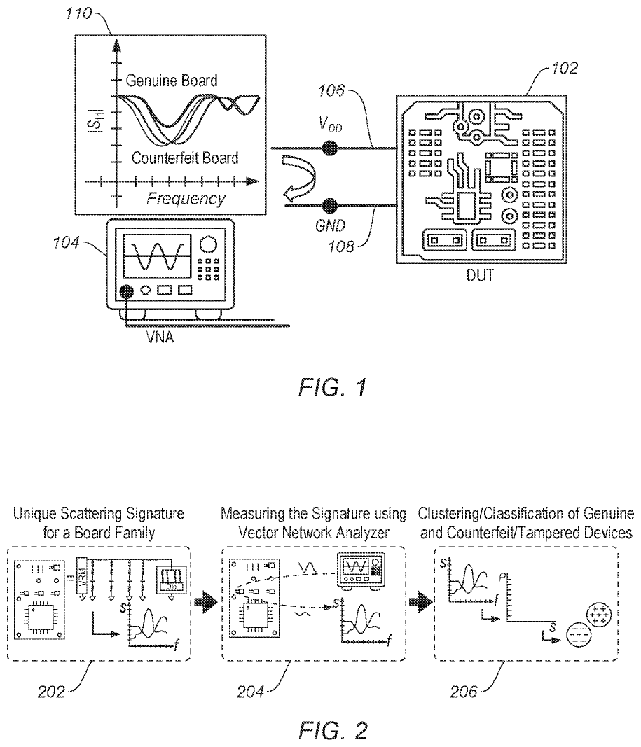

FIG. 1 illustrates a setup for characterizing a PDN according to one embodiment of the present invention. As shown, a device-under-test (DUT) 102 is connected to a VNA 104 via a voltage supply (VDD) 106 and a ground (GND) 108. A sample graph 110 illustrates exemplary results of measurements of the PDN conducted with the VNA 104.

To characterize a PDN, power and signal integrity analyzes can be carried out using measurement equipment, such as vector network analyzers (VNAs) as shown in FIG. 1. Power integrity analysis deals with the quality of the power delivery (i.e., voltage and current) to different components on a PCB. Issues such as voltage drop, voltage ripple, and crosstalk can occur if the board is poorly designed. The main physical parameter affecting the quality of power delivery is the impedance of the PDN. While on a PCB, the resistance of the power plane is the main cause of the DC voltage drop between the voltage regulator and ICs, decoupling capacitors are causing the voltage ripple when alternating current (AC) is consumed by switching activities of the IC's transistors. Moreover, the inductance resulting from capacitor parasitics and bonding wires/balls of the IC package creates resonance in PCB impedance at specific current frequencies.

Signal integrity analysis checks the quality of delivery of an electrical signal (e.g., a data signal) between two points on the PCB. Issues such as attenuation, reflection, dissipation, interference, and crosstalk can occur on poorly designed data paths on the PCB. In digital circuits, for high-frequency data streams, the bit period and rise/fall times of the signals play essential roles in designing the PCB. For such high data rates, proper impedance matching has to be taken into account to avoid signal bouncing/reflection causing intersymbol interference (ISI) and bit errors. Moreover, the PCB traces and vias' geometry affects the quality of the signal propagation on the PCB.

Since there are different electrical effects on PCBs, such as signal attenuation and signal reflection, and because each component contributes to the PDN's impedance, the primary way to characterize these effects in a unified manner is to use Z (impedance) and S (scattering) parameters. These parameters are employed in power/signal integrity analyses of electronic systems to describe the electrical properties of linear electrical networks (e.g., networks consist of resistors, capacitors, and inductors). These parameters are complex numbers (including voltage amplitude and phase of traveling waves) and functions of frequency. Based on the number of electrical ports, these parameters are represented in matrices with different sizes. S-parameters directly represent the attenuation and reflection/transmission ratio of the signal at each port of a network. Z-parameters, however, can be used to derive the observed impedance at each port of a network. A VNA, as shown in FIG. 1, can be used to measure these parameters. Measuring Z-parameters at a port requires other ports to be terminated into open circuits. Measuring S-parameters, however, does not require this condition, and instead, match loads can be used. Depending on the measurement conditions, it might be more convenient to measure one of these parameters and then convert it to the other one.

As noted, any tampering and counterfeiting attempt on the PCB will lead to changes in the equivalent impedance of the PDN. It should be noted that the contribution of each individual component to the PDN's impedance is distinct at different frequencies. While in lower frequencies, the equivalent impedance of the PDN is dominated by the voltage regulator's characteristics, and in higher frequencies, the off-chip and on-chip components are contributing most to the impedance. Consequently, changes in the impedance in different frequencies affect both S- and Z-parameters. As measuring the S-parameters is more convenient in practice using VNAs, they can be used for the characterization of the PDNs for purposes of detecting tampering or counterfeiting. More specifically, the reflection coefficient (S₁₁) parameter can be selected for analysis, which allows the measurement setup to be simplified because only one access point (i.e., electrical terminal consists of voltage and ground) is needed on the PCB to perform the characterization. In other words, verification can be achieved using a single measurement.

Returning to FIG. 1, the sample graph 110 illustrates exemplary results of measuring S₁₁. As shown, S₁₁ (shown on the y-axis) was measured across a range of frequencies (shown on the x-axis). The change in S₁₁ across this range of frequencies can be compared for a genuine PCB in a genuine DUT versus a counterfeit PCB in a counterfeit DUT. This comparison allows for the determination of whether the DUT 102 is genuine or has been tampered with or contains any counterfeit components. It should be appreciated that the S-parameter includes two components, namely the amplitude (|S₁₁) and the phase (∠S₁₁). Accordingly, either or both can be used for comparison and, therefore, for purposes of determining whether tampering or counterfeiting has occurred. As described below, in some cases either the amplitude or the phase may be more or less sensitive to the tampering or counterfeiting that was done.

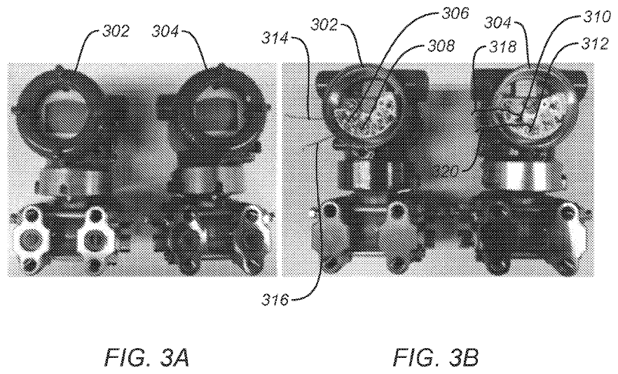

FIG. 2 illustrates the method for identifying tampered or counterfeit devices according to one embodiment of the present invention. Generally, a unique scattering signature or impedance signature 202 for a given PCB or board family is known. Then, in a first step 204, the PDN of the subject PCB is characterized, which includes measuring the S-parameter data for a given device or DUT and may also include mathematical modeling of the data. As described below, it should be appreciated that mathematical modeling of the data may or may not be necessary. In a second step 206, the results from the first step, which may include the results of the mathematical modeling, are evaluated to determine whether the PCB is authentic or a counterfeit or whether it has been tampered with. Each of these steps is described in more detail below.

In the first step 204, the PDN of a subject PCB or device is characterized or the PDN signature of the PCB or device is measured. In the first step 204, and with reference to FIG. 1, a VNA can be used to measure the S-parameters of a set of PCBs, specifically the S₁₁ parameter. In some embodiments, a linear frequency sweep from 100 kHz to 200 MHz and 100 kHz to 1 GHz with an intermediate frequency bandwidth of 100 kHz using 201 measurement points can be used. The output power level of the network analyzer can be set to 0 dBm, with starting and stopping power levels of −10 dBm and 0 dBm, respectively. It should be appreciated that the collected date in this step represents the S-signature for the device being evaluated.

As noted, the data collected from the PDN can be mathematically modeled using machine learning techniques in preparation for comparison in the second step 206 to determine whether tampering or counterfeiting is present. It should be appreciated that in some instances mathematically modeling may or may not be necessary. In some cases, the change in the S-signatures between the measured S-signature of the device being evaluated and the known S-signature may be large enough, or very large, for direct comparison. In that instance a direct comparison of the amplitude of the S-signatures (e.g., by subtraction) provides sufficient differences to allow for a determination of whether the device has been subjected to tampering or is a counterfeit device without the need for mathematical modeling or machine learning techniques. In other cases, such as those in which the tampering may be more sophisticated and in which the S-signature is relatively small or provides a small footprint or the differences are relatively small, mathematical modeling of the collected data can be used to determine whether tampering or counterfeiting has occurred. One of skill in the art will appreciate the distinction in such cases to understand when and whether machine learning or mathematical modeling should be used.

To detect tampering, machine learning can be used in both supervised (i.e., classification) and unsupervised (i.e., clustering) scenarios. The data collected from S-parameter measurements is noisy and multidimensional, as it is collected over pre-defined time and frequency ranges. The sequence of the S-parameters data over frequency also exhibits the characteristics of a time series, although being non-temporal. Therefore, classifying/clustering the collected data can be thought of as a sequence labeling problem that is addressed by applying time-series analysis. Specifically, a state-space model (SSM) can be used, which is an approach used to analyze sequential, structured, time series-like data. In an SSM, the sequence of measured data is assumed to be generated by some hidden state variables, which would include the resistance, capacitance, and inductance of the PDN at each frequency, resulting in the overall impedance. It should be appreciated that these hidden state variables can be impacted by environmental noise, device aging, or noise imposed by the measurement. These physical uncertainties are assumed to follow a Gaussian distribution. Therefore, a straightforward class of SSMs, called linear Gaussian state-space models, can be used. Formally, a sequence of measured data y (in a vector form) y1, y2, . . . is collected over a frequency range. This sequence is generated by some hidden state variables x1, x2, . . . with joint probability as shown in Equation 1:

$$p ( {x}_{1 : F} , {y}_{1 : F} \vert θ ) = {\prod }_{f = 1}^{F} p ( {x}_{f} \vert {x}_{f - 1} , θ ) p ( {y}_{f} \vert {x}_{f} , θ ) \qquad Eq . 1$$

where θ is the model parameter, X_{1:F} and y_{1:F} are the sequence of F sequences of the hidden state variables and the measurements, respectively. As Gaussian distributions can model various physical phenomena, linear-Gaussian SSMs composed of multivariate following Equations 2 and 3 can be used:

$${y}_{f} = {Cx}_{f} + {v}_{f} \qquad Eq . 2$$

$${x}_{f} = {Ax}_{f - 1} + {w}_{f} \qquad Eq . 3$$

where vectors v and w represent uncertainty and follow Gaussian distributions, with covariance matrices R and Q, respectively. In other words, these two vectors account for the total impact of aging, environmental noise, uncertainty imposed by the measurement process, and so forth. Parameters of a PCB are represented by θ=(A, C, Q, R).

Another important aspect of the data representation is the dependency of the hidden state variables on one another. Since continuous electrical current generation at each step of measurement increases the temperature of the board and its components, the measurement at each time/frequency step would be affected by the previous measurement. Consequently, the state variables have first-order Markov dynamics.

It should be appreciated, based on the availability of the golden sample, the verification method can be used for supervised and unsupervised scenarios. In the unsupervised scenario, to learn the parameters of the linear Gaussian SSM (Equation (1), a well-studied approach is the expectation-maximization (E-M) algorithm. This algorithm is the building block of Gaussian mixture models that can cluster objects based on SSMs. In this regard, a Gaussian mixture model makes use of hidden Gaussian states to assign each measured data y to a cluster. Each cluster corresponds to a Gaussian distribution with the mean and variance that are cluster specific and learned by employing the E-M algorithm.

In the supervised scenario, however, the K-nearest neighbors (KNN) algorithm can be used, which is a close approach to the E-M algorithm. The reason behind selecting KNN algorithms is that examples exhibiting similar properties should be in close proximity to one another in a dataset.

As an example, in some embodiments, and as described in the Examples below, a statistical and machine learning framework in MATLAB can be used. To this end, off-the-shelf algorithms can be used to fit Gaussian mixture models to the collected data. For these algorithms, it is necessary to define the number of Gaussian distributions contributing to the model (i.e., the number of clusters). In addition to the number of clusters, parameters needed for determining the clusters (i.e., distance metric and clustering evaluation criterion) are adjusted automatically. In doing so, a gap criterion can be selected to evaluate the clusters. In other words, the gap statistic reflects the compactness of clusters by calculating the total intra-cluster distance variation for different numbers of clusters. Furthermore, the cityblock distance metric can be chosen to maximize the performance of the clustering. The cityblock distance (also called Manhattan distance) is used to calculate the distance between two data points in a grid-like path for high-dimensional data, similar to the data collected in these tests. As described above, fitting a Gaussian mixture model can be performed by applying the E-M algorithm, realized by the k-means algorithm in MATLAB. As for supervised machine learning, the KNN algorithm included in the MATLAB software suite can be used. Similar to the approach for the unsupervised Gaussian mixture model mentioned previously, the KNN algorithm parameters (i.e., the number of neighbors and the distance metric) are set in an automatic manner. To assess the performance of the classification algorithm, leave-one-out cross validation can be used. As a result, the data collected from all PCBs can be fed into the KNN algorithm: the data collected from each PCB is once used as the test data, whereas all other instances serve as a training set. In general, the advantage of cross-validation methods is that the results are less biased. Specifically for leave-one-out cross validation, the computation complexity is low.

As described above, in the second step 206, the results from the characterization of the PDN of the PBC in question, which may include the results of the mathematical modeling, are evaluated or compared. As described above, the S-parameter includes two components, namely the amplitude (|S₁₁|) and the phase (∠S₁₁). Accordingly, either or both can be used for comparison as in some cases either the amplitude or the phase may be more or less sensitive to the tampering or counterfeiting that was done.

Generally, there are two scenarios that can be addressed in this second step 206. First, the results can be used to determine whether the PCB in question has been tampered with or is a counterfeit or contains counterfeit components. In other words, this step 206 can be used to identify or differentiate legitimate versus tampered devices. Second, the results can be used to differentiate what are believed to be two legitimate devices. Each of these is described below.

In the first scenario, in determining whether the device has been tampered with or is counterfeit, in some embodiments, the user or verifier may have a golden sample and can perform the same PDN analysis on the golden sample to provide a characterization of the PDN to which the results for the PCB in question can be compared. As a result, the verifier can perform measurements and characterize this golden sample. To verify every other device, the verifier has to carry out the same characterization and compare the resulting signatures with the golden one. The existence of differences between these two PDN characterizations would identify the existence of tampering or counterfeiting.

It should be appreciated, however, that in some cases, the measurements may suffer from noise such that the mathematical modeling described above should be employed. A first type of noise stems from the uncertainties during the measurement because of either the changes in the environmental conditions or else the thermal noise in the measurement equipment. The adverse effect of this kind of noise can be reduced by repeating the same measurement and by better controlling the environmental conditions. A second type of noise is caused by manufacturing process variations. Unlike the first type, process variation noise cannot be mitigated. Even if two devices are genuine, they may still show differences in their physical signature.

It should be appreciated that if the user or verifier has only access to a golden sample, only unsupervised (i.e., clustering) methods to find out whether the signatures of suspicious devices belong to the same cluster or not. The main advantage of this approach is that the verifier does not require any knowledge about the behavior of the tampered/counterfeited devices as any signature with enough difference to the golden signature is clustered differently.

In some embodiments, the user or verifier may also have access to some tampered or counterfeit samples. In this case, the verifier can assign labels to the golden and all other attacked samples and deploy supervised (i.e., classification) techniques. The advantage here is that an unseen sample from the known attacked categories can be detected with high confidence.

In the second scenario, directed to differentiating what are believed to be two legitimate devices, the distance between signatures of the legitimate devices can be used as a fingerprint to authenticate each individual sample. Such fingerprinting is useful in attack scenarios, where an electronic board might be replaced by a similar one. Although both boards could be genuine, the boards may have different software versions, which cannot be detected easily by physical measurements.

It should be appreciated that the method of the present invention can be applied to any electronic board at any time. In some embodiments, the method may be used prior to deployment of the device into the field so as to authenticate the device prior to use. In some embodiments, the method may be used at various points along the manufacturing or supply chain and can be used to evaluate various types of tampering or counterfeiting, including, for example, malicious implants on a PCB or the use of counterfeit or recycled components.

The following Examples provide further description regarding the implementation of the method of the present invention. Specifically, the Examples provide further description on how to measure a PDN, how to mathematically model the results, and how to utilize the results to determine the authenticity of a given device.

### Examples

Evaluations of various devices were performed to test the method of the present invention. In one case, a genuine and a counterfeit Yokogawa EJX110A differential pressure transmitter were evaluated. Specifically, the differences in the S₁₁ signatures between the genuine and counterfeit devices was evaluated. In a second case, Texas Instruments LP-MSP430FR2476 development kits were evaluated to show the effect on the S11 signature in light of various tampering actions. To emulate tampering actions or attacks on the Texas Instrument devices, capacitors, resistors, and inductors from the PCB's plane were desoldered and then the S₁₁ parameter was measured. Among different components on the PCB, tampering with capacitors is more crucial for three reasons. First, capacitors play a crucial role in delivering high-quality power to the ICs on the PCB. Second, the capacitors may be the most counterfeited products in the market. Third, changing any other components on the PCB, such as implanting a spy chip, will cause changes in overall capacitance (and naturally, the overall impedance) of the PDN, but this attack type can be emulated by capacitors. It should be appreciated that in a supervised (i.e., classification) scenario, S-parameter measurements are compared with genuine PDN signatures in an enrollment phase for the detection of attacks. However, in an unsupervised scenario, the S-parameters are used for fingerprinting and verification. In a third case, Texas Instruments MSP-EXP432P401R development kits were evaluated to show the effect on the S₁₁ signature in light of incremental tampering and how the method of the present invention can detect such.

For S-parameter measurement, a Keysight ENA Network Analyzer E5080A was used. A linear frequency sweep from 100 kHz to 200 MHz and 100 kHz to 1 GHz with an intermediate frequency bandwidth of 100 kHz was set using 201 measurement points. The output power level of the network analyzer was set to 0 dBm, with starting and stopping power levels of −10 dBm and 0 dBm, respectively. The network analyzer was used only for measuring the reflection coefficient (S₁₁). A shielded cable was used as an adapter between an SMA connection and pins of the DUTs. Since the network analyzer's signal path could only be calibrated up to the SMA connection, a constant offset was added to the measurements based on using the same connector. As the main purpose of experiments was to detect a difference between the measurements of genuine and tampered/counterfeit samples, the presence of this constant offset in all measurements does not affect the results.

In some cases, to analyze the data collected from these tests, a statistical and

machine learning framework in MATLAB was used, noting that the algorithm can be implemented using any known software suite. To this end, off-the-shelf algorithms were used to fit Gaussian mixture models to the collected data. For these algorithms, it is necessary to define the number of Gaussian distributions contributing to the model (i.e., the number of clusters). In addition to the number of clusters, parameters needed for determining the clusters (i.e., distance metric and clustering evaluation criterion) are adjusted automatically. In doing so, the gap criterion was selected to evaluate the clusters. In other words, the gap statistic reflects the compactness of clusters by calculating the total intra-cluster distance variation for different numbers of clusters. Furthermore, the cityblock distance metric was chosen to maximize the performance of the clustering. The cityblock distance (also called Manhattan distance) is used to calculate the distance between two data points in a grid-like path for high-dimensional data, similar to the data collected in these tests. As described above, fitting a Gaussian mixture model was performed by applying the E-M algorithm, realized by the k-means algorithm in MATLAB. As for supervised machine learning, the KNN algorithm included in the MATLAB software suite was used. Similar to the approach for the unsupervised Gaussian mixture model mentioned previously, the KNN algorithm parameters (i.e., the number of neighbors and the distance metric) are set in an automatic manner. To assess the performance of the classification algorithm, leave-one-out cross validation was used. As a result, the data collected from all PCBs were fed into the KNN algorithm: the data collected from each PCB is once used as the test data, whereas all other instances serve as a training set. In general, the advantage of cross-validation methods is that the results are less biased. Specifically for leave-one-out cross validation, the computation complexity is low.

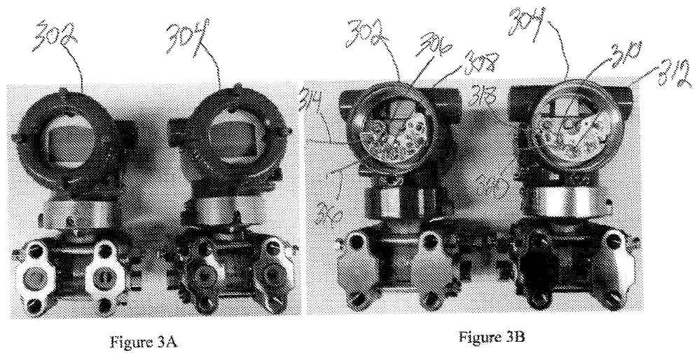

FIG. 3A shows the Yokogawa EJX110A differential pressure transmitters. The leftmost transmitter 302 is a counterfeit version, and the rightmost transmitter 304 is a genuine version. These differential pressure transmitters are typically used for measuring liquid, gas, or steam pressure. Specifically, an internal digital sensor measures the differential pressure, static pressure, and temperature simultaneously. As a result, it can compensate for the pressure and temperature differences in real time.

FIG. 3B illustrates a rear view of the transmitters of FIG. 3A. As shown in FIG. 3B, four electrical terminals 306, 308, 310, 312, two of which are used for supplying DC voltage to the inside PCB are accessible and can be used to access the power rails inside the electronic boards. Cables 314, 316, 318, 320 are connected to these terminals to measure the reflection coefficient (S₁₁) of the inside electronic board.

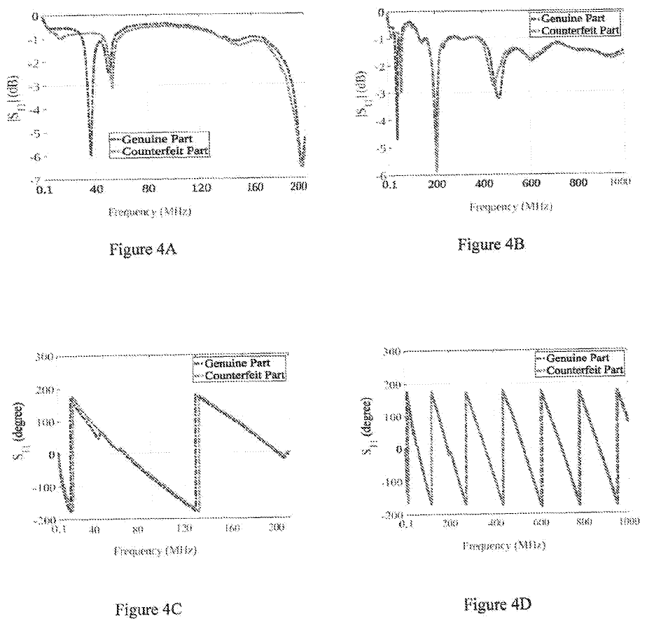

FIG. 4A-D illustrate the results of testing of the Yokogawa EJX110A differential pressure transmitters of FIG. 3A. PDN characterizations were performed in two ranges of frequency, i.e., from 100 kHz to 200 MHz and 100 kHz to 1 GHz. As shown in FIGS. 4A and 4B, the measured S₁₁ amplitudes from both devices show similar patterns over frequency except for two frequency intervals, namely from 45 to 60 MHz and 400 to 500 MHz. This result indicates that the PDNs' characteristics of electronic boards inside these two products are different.

To evaluate the effect of counterfeiting activities on the phase of the reflection response of the pressure sensor, the phase of the reflection coefficient of the Yokogawa EJX110A sensor was also measured in two ranges of frequency (100 kHz to 200 MHz and 100 kHz to 1 GHz). These results are shown in FIGS. 4C and 4D. By comparing the amplitude and phase changes, more sensitivity in |S₁₁| rather than ∠S₁₁ can be observed. It should be appreciated that some changes in the phase profile are detectable; however, the pattern of the phase response is not changed remarkably for the counterfeit sample.

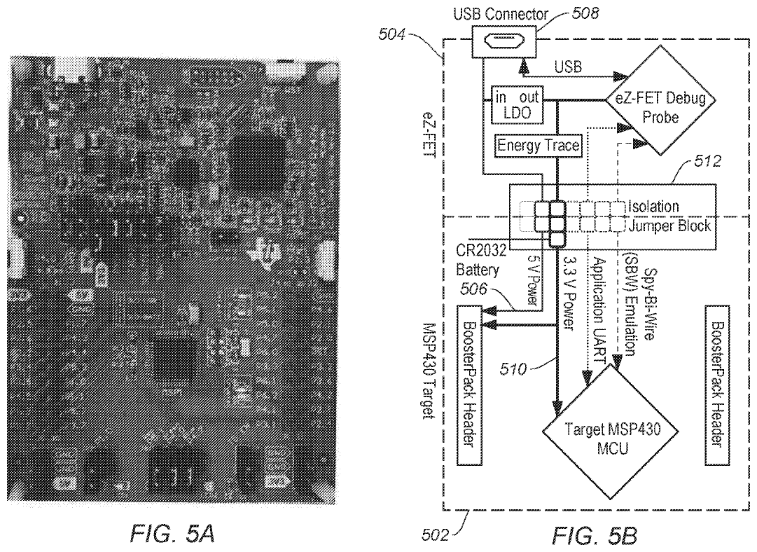

FIGS. 5A-B illustrate the Texas Instruments LP-MSP430FR2476 development kit and corresponding schematic. Texas Instruments MSP430FR2476 LaunchPad development kits (LP-MSP430FR2476) were used for different tampering experiments. As shown, the MSP430FR2476 development kit consists of two connected PCBs, namely the MSP430 Target 502 and eZ-FET 504. The kit contains two separate PDNs. A direct 5V voltage supply 506 from the USB port 508 delivers power for potential extension boards, whereas a 3.3V PDN 510 is responsible for powering up the microcontrollers on both PCBs. As most components of the PCBs are connected to the 3.3V PDN, this PDN was used. To measure the reflection coefficient (S₁₁) of the PDN, direct access to the 3.3V PDN was needed. Although the 3.3V is generated by a low-dropout regulator, it is directly accessible for measurement on a jumper/isolation block 512.

It should be appreciated that to rely on S₁₁ signatures in an enrollment phase for tampering and counterfeit detection of an unseen sample, the S₁₁ signatures have to show consistency between boards from the same family. Although similar electronic boards can be manufactured by the same foundry using the same material, there are still manufacturing process variations leading to differences in signatures. To measure the effect of the process variations between boards, S₁₁ measurements were performed on 10 MSP430FR2476 development kits in the bandwidth of 100 kHz to 900 MHz.

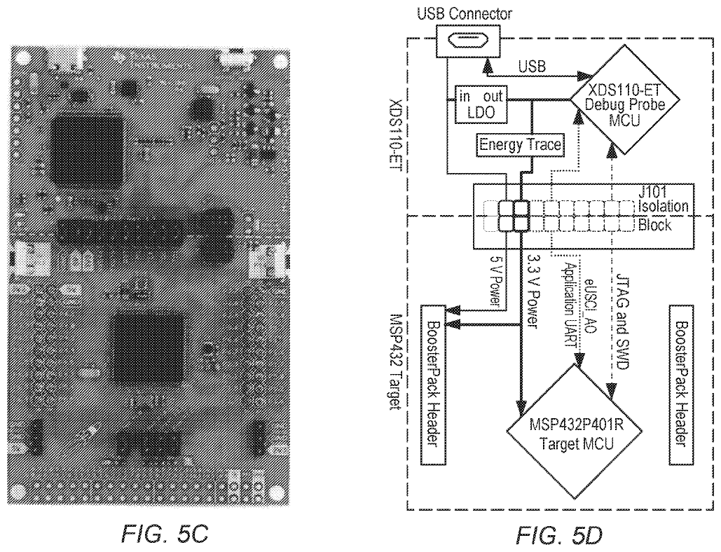

FIGS. 6A and 6B illustrate the results of S₁₁ measurements on 10 MSP430FR2476 development kits. As shown, all 10 boards are indicating similar S₁₁ signature patterns (including both the amplitude and the phase profile of S₁₁) over frequency, whereas there are small deviations due to the manufacturing process variation.

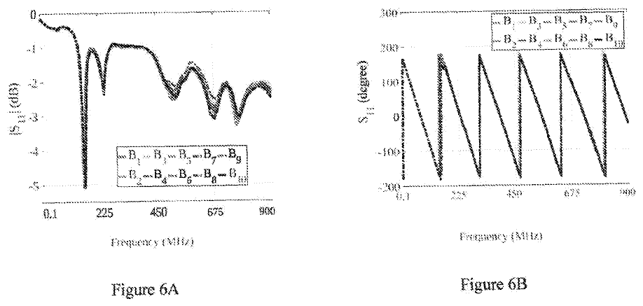

FIGS. 7A and 7B illustrate six different tampering attacks on seven MSP430FR2476 development kits and the resulting S₁₁ measurements in the bandwidth of 100 kHz to 1 GHz. Seven boards within the same family from MSP430FR2476 development kits were used. The S₁₁ parameter of one of the boards was measured to keep it as the reference (genuine) PCB, which is the board shown in the center of FIG. 7A. Six different tampering attacks were then performed on the remaining six PCBs, including two short circuits, removing C₂ and C₁, refurbishing, removing jumpers, adding a via, and a trace cut, as illustrated in FIG. 7A. In attack 1, traces were cut at the left side of one of the boards to see its effect on the signature of the reflection response. Specifically, traces were cut connecting R12, R13, and C7 to P1.1 and P1.0 pins. In attack 2, a soldering iron was added to some unsoldered connections on one of the PCBs to see the effect of adding a short circuit on the Sun behavior. To be more specific, the electrical pads on the PCB reserved for two resistors R9 (47 KΩ) and R10 (47 KΩ) were soldered, which were disconnected by default. In attack 3, a part of the PCB was painted using conductive wire glue to check its impact. This paint contains carbon and a non-toxic binder. Wire glue was added on R9 and R10 resistors and dried. Thereafter, the S₁₁ of the refurbished PCB was measured over frequency. In attack 4, all jumper blocks of one of the PCBs were removed to check the impact of adding/removing jumpers as well. Note that the middle jumper block (J101) was removed in all measurements to have direct access to the 3.3V line and its ground pin using a custom cable (see the board in the center of FIG. 7A). However, in attack 4, other jumper blocks (J7, J8, and J9) in the bottom side of the PCB were removed as well. In attack 5, the ground plane of one of the boards was drilled to simulate adding a via to the PCB. Note that a via was placed in the ground plane between J7 and J8 jumper blocks (see FIG. 7A) using a drilling machine with a drill diameter of 1.02 mm. In attack 6, capacitors C1 (10 μF) and C2 (0.1 μF) were removed simultaneously to see the effect of component removal on the S₁₁ parameter.

FIG. 7B illustrates the results of measuring the S₁₁ parameter for each board with the respective tampering attack in the bandwidth of 100 kHz to 1 GHz. It is observed that each of the tampering activities has a considerable impact on the amplitude of the reflection response of the PCB. Both the amplitude and the resonance frequency are altered after each tampering attack. Notably, the tampered boards worked properly after the attacks. This observation confirms that a functional test cannot be considered an effective and accurate technique for detecting such tampering activities.

It should be appreciated that with respect to attack 6, it can be observed that the pattern, amplitude, and resonance frequencies are remarkably altered, noting that the phase profile of these tampering experiments was captured as well. Interestingly, in the case of simultaneous removal of C1 and C2 capacitors, an observable change in ∠S11 was seen as well. However, this change is dependent on the periodic nature of the ∠S11. Therefore, if a higher level of tampering occurs, in which ∠S11 goes back to its initial state, such tampering may remain undetected via the inspection of the phase profile.

Additional tests were performed using 20 MSP430FR2476 development kits from different manufacturing facilities. Specifically, the S₁₁ experiments (in the bandwidth of 100 kHz to 900 MHz) were performed on these boards to classify them. All boards were from the same family and had exactly the same design; however, they were assembled at different facilities of Texas Instruments.

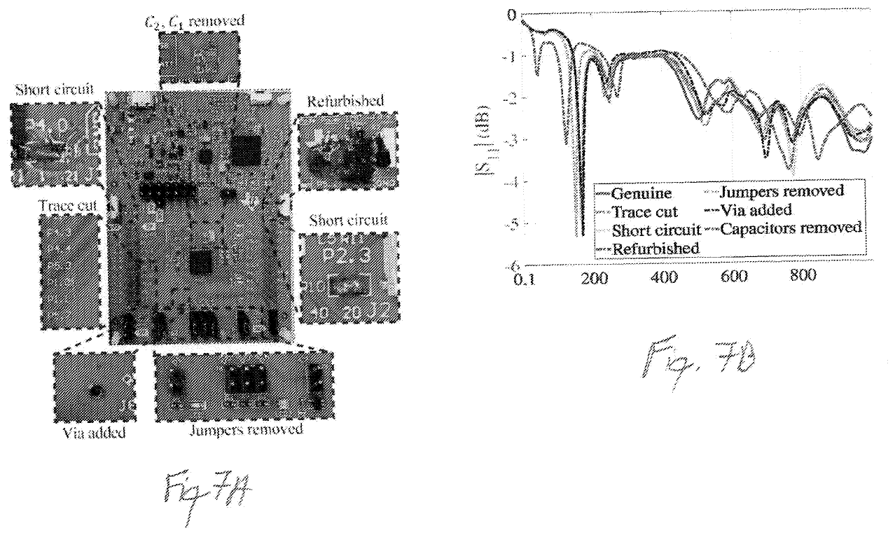

FIG. 8 shows the backside of two different groups of MSP430FR2476 boards. After characterizing S₁₁ signatures of these boards, 10 of them have their first resonance at approximately 144 MHz (group 1), and the other half (group 2) have their first resonance at roughly 171 MHz. As seen in FIG. 8, the color and the marking of the boards in group 1 and group 2 are different.

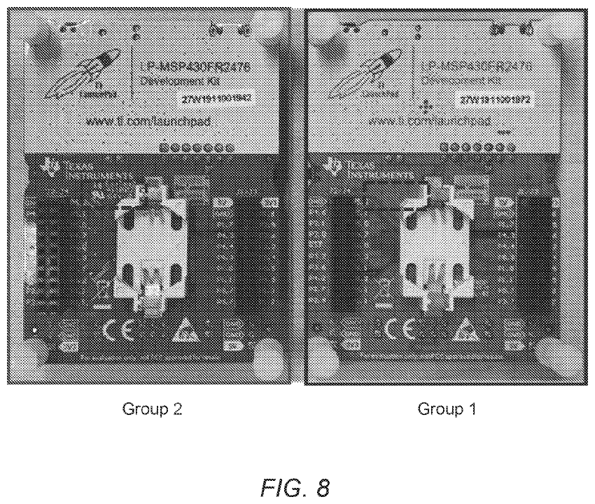

FIGS. 9A and 9B illustrate the results of S-parameter measurements for the two different groups of MSP430FR2476 boards. To better demonstrate the change in the S₁₁ signature of these PCBs, the average of the |S₁₁| and ∠S₁₁ of each group were plotted the over frequency. The averaged amplitude and the phase of the reflection response of these 20 boards. Although all 20 boards are legitimate samples, they show different S₁₁ behavior over frequency. As shown in FIG. 9B, the phase of the reflection response of these two groups of MSP430FR2476 boards does not reveal much information about the PCBs. However, visible changes are more detectable in the amplitude profile of the reflection response (see FIG. 9A). Therefore, it is evident again that the phase profile is not a secure metric to detect sophisticated tampering in which the sample under test is highly similar to the genuine one.

Returning to FIG. 5, FIGS. 5C-D illustrate the Texas Instruments MSP-EXP432P401R development kit and corresponding schematic. The MSP432P401R kit consists of two connected PCBs, namely the MSP432 Target 552 and XDS110-ET 554. The kit contains two separate PDNs as well 556, 558. Since the 3.3V 558 is responsible for power delivery to the microcontroller and other main components, this PDN was used. Whereas the tampering tests above performed using the MSP430FR2476 boards were intended to show the impact of various tampering activities separately. The tests on the MSP-EXP432P401R boards validates the verification technique via more extensive gradual tampering experiments and the use of machine learning algorithms to distinguish between different levels of the gradual tampering. It should be appreciated that there are a larger number of available components in MSP432P401R kits compared to the LP-MSP430FR2476 of FIGS. 5A-B. Therefore, the machine learning approach described above was only applied to MSP432P401R boards' experiments due to the higher level of tampering possibilities, which is a result of the larger number of available components in MSP432P401R kits.

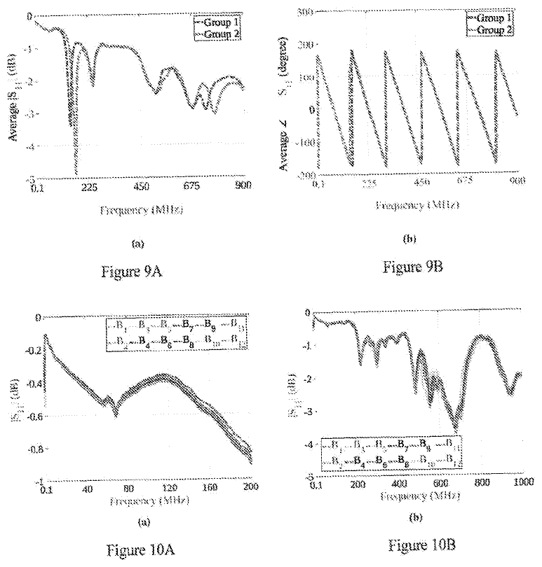

FIGS. 10A and 10B illustrate the results of the S₁₁ measurements on 12 Texas Instruments MSP432P401R development kits. As shown, all 12 boards demonstrated similar S₁₁ signature patterns over frequency, whereas small deviations are due to the manufacturing process variation.

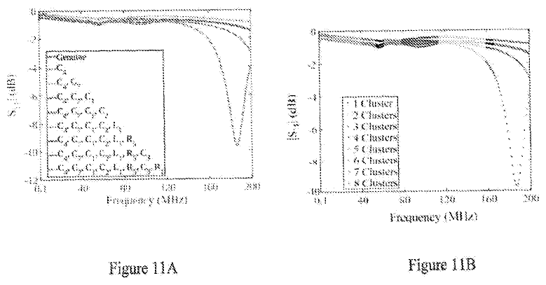

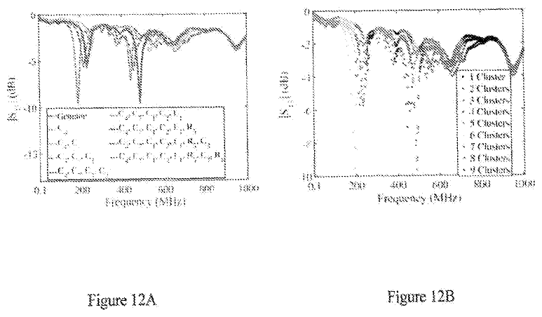

FIG. 11A illustrates the results of the S₁₁ measurements on 12 Texas Instruments MSP432P401R development kits in the bandwidth of 100 kHz to 200 MHz based upon gradual removal of electrical components. FIG. 12A illustrates the results of the S₁₁ measurements on 12 Texas Instruments MSP432P401R development kits in the bandwidth of 100 kHz to 1 GHz based upon gradual removal of electrical components. To assess the effect of gradual tampering on the S₁₁ signatures, one of the MSP432P401R development kits was selected and different components were gradually removed from the board. As can be seen on the MSP432 target board in FIG. 5C, there are several passive electrical components around the main microcontroller, which can be considered. According to the kit documentation, some of these components, such as decoupling capacitors C3 (10 μF), C4 (100 nF), and C7 (100 nF), are connected directly to the 3.3V line and the ground. There are other decoupling capacitors for the analog voltage supply of the chip, such as C1 (100 nF) and C2 (100 nF), which are separated from the 3.3V power line by resistor R1 (0Ω). Components only connected to the ground (e.g., R5 (91 kΩ) or that have no connection to the 3.3V line and ground (e.g., L1 (4.7 nH)) were also considered.

In what are referred to as “tampering levels,” various components were successively removed from the board. In tampering levels 1 through 4, the decoupling capacitors (C4, C7, C1, and C2) were removed one by one for the digital and analog power supply. Tampering levels 5 and 6 included removal of components with no direct connection to the 3.3V PDN (i.e., L1 and R5). In tampering level 7, the decoupling capacitor with the largest capacitance (C3) was removed. Finally, in tampering level 8, the resistor R1, which fully disconnects the PDN from the measurement point on the jumper/isolation block (see FIG. 5C), was removed. The impact of the gradual removal of these components on the S₁₁ signature of the PCB in the frequency ranges of 100 kHz to 200 MHz and 100 kHz to 1 GHz is shown. The various tampering levels are shown in the legend of each figure.

One interesting observation is that different tampering levels have an impact on different portions of the spectrum. Although each level of tampering affects the S₁₁ signature in a specific frequency range, its pattern remains intact in a large portion of the spectrum. The main differences can be observed by looking at the shifts of resonance points in frequency as well as their amplitude. This is due to the dependence of resonance frequencies on the inductance and capacitance of the overall PDN. Therefore, any removal, addition, or replacement of components, which affect the inductance and capacitance of the PDN, leads to a shift in resonance frequency. As a result, any local impedance measurement on PCBs for verification purposes, which does not scan a large range of frequency, might provide an inaccurate result and leave the tampering/counterfeiting undetected.

The largest impact of removing decoupling capacitors on the S₁₁ signature can be observed in frequencies larger than 160 MHz. Compared to decoupling capacitors, the removal of L1 and R5 has small influences on the S₁₁ signature. Finally, as expected, removing R1 in the last level of tampering has the highest impact on the S₁₁ behavior as it disconnects the remaining components on the PDN of PCB from the measurement probes.

The phase profiles of these tampering experiments on MSP432P401R boards were captured as well. Interestingly, the phase profile was not affected so much up to level 6 of the gradual tampering. This observation confirms that the phase profile is not an appropriate metric to detect sophisticated tampering, in which the tampered DUT is similar to the legitimate sample. As the level of tampering level increases from 6 to 8 (more components are removed), the phase profile is considerably shifted forward. However, this change is dependent on the periodic nature of the ∠S₁₁. Therefore, in higher levels of tampering, ∠S₁₁ goes back to its initial state, and consequently, such tampering remains undisclosed via the inspection of the phase information.

As noted, the machine learning procedure described above was applied to the collected S₁₁ signatures to automate the process of tampering detection. Two scenarios were evaluated.

In a first scenario, referred to as “unsupervised learning,” the objective was to determine whether the unmodified PCB and each modified versions after tampering can be differentiated automatically without the user knowing which is which or without having labels for each PCB. In other words, the verifier does not know anything about the S₁₁ signature of the genuine device, and thus tries to cluster devices based on their collected signatures. As described above, a Gaussian mixture model was used to assign each measurement to a cluster. In fact, each cluster represent a Gaussian distribution with the mean and variance learned by employing the E-M algorithm.

FIG. 11B illustrates the clustering results of the S₁₁ measurements on 12 Texas Instruments MSP432P401R development kits in the bandwidth of 100 kHz to 200 MHz based upon various tampering levels. FIG. 12B illustrates the clustering results of the S₁₁ measurements on 12 Texas Instruments MSP432P401R development kits in the bandwidth of 100 kHz to 1 GHz based upon various tampering levels. These are the results for the first scenario described above.

Based on the results as shown in FIGS. 11B and 12B, the unsupervised learning can learn at most eight clusters at some frequency ranges between 100 kHz to 200 MHz, all nine clusters (i.e., genuine and eight tampering levels) can be successfully learned in specific frequency ranges based upon the obtained S₁₁ signatures in frequencies between 100 kHz and 1 GHz. It should be appreciated that the number of clusters corresponds to the number of Gaussian distributions determined by the algorithm. Furthermore, no restriction was imposed on the number of clusters, and consequently, the number of Gaussian distributions underlying the measured data. It should be appreciated that the statistical and machine learning analyses could detect the removal of R5 and L1 components, as they were not directly connected to the 3.3V PDN. This can possible be explained by the crosstalk of components on PCB and the overall effect of them on the ground plane.

In a second scenario, referred to as “supervised learning,” the objective was to evaluate the detection accuracy of modified PCBs by providing correct labels to the learning algorithm in the training phase. In this case, the verifier has already characterized different versions of the modified board and hence can provide the corresponding labels. This means that at least one genuine and one tampered PCB is available, where the verifier could prepare the latter by removing some components from the PCB, for instance. In this case, the verifier not only detects a deviation from the genuine PCB but can exactly learn what kind of tampering attack has been mounted on the board. Based on the obtained clustering results, a classification algorithm was run on frequency ranges where all tampering levels could be clustered and differentiated. In other words, the frequency range was taken into account, where the maximum number of Gaussian distributions (the maximum number of clusters, accordingly) could be determined by the algorithm.

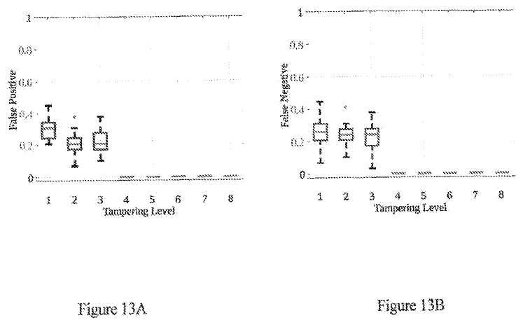

FIGS. 13A and 13B illustrate the detection accuracy for labeled PCBs. Specifically, FIG. 13A illustrates false positive (FP) results, and FIG. 13B illustrates false negative (FN) results. For highly confident detection, FP and FN ratios close or equal to zero would be ideal. This was achieved after tampering level 4 (i.e., C4, C7, C1, and C2 removed), whereas for tampering levels 1 through 3, relatively low FP and FN ratios (i.e., up to 30%) were still achieved.

In addition to this observation, in Section 6.3.4, we explore how statistical and machine learning methods can be helpful to differentiate between the fingerprints of the tampered and genuine PCBs. Specifically, the statistical distance of S₁₁ signatures between the legitimate (unmodified) boards as well as between legitimate and tampered boards was analyzed to determine whether the process variation on legitimate boards is sufficient that S₁₁ signatures provide a unique signature for each board.

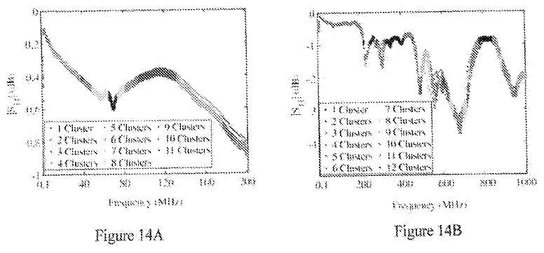

FIGS. 14A and 14B illustrate the clustering results of 12 legitimate boards. To derive the distance of S₁₁ signatures for legitimate boards, unsupervised learning as described above was applied to the 12 legitimate (unmodified) TI MSP432P401R development kits. As can be observed in these figures, in specific frequency ranges, the process variation provides enough deviations between legitimate boards. Consequently, all legitimate boards can be uniquely identified.

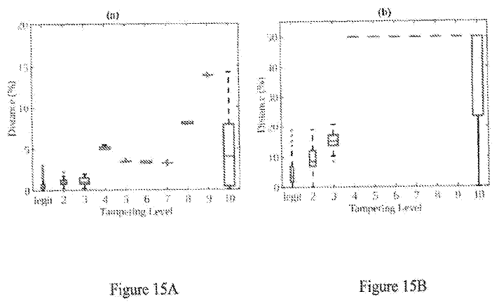

FIGS. 15A and 15B illustrate the statistical distance for 12 legitimate boards and for legitimate versus tampered boards. Specifically, the statistical distance of the legitimate board's signatures among themselves and the tampered versions of the boards was also analyzed. The statistical distances were calculated both over the entire frequency range and specific frequency ranges, which corresponds to the maximum number of clusters and, consequently, the maximum variations between measured data. In both cases, the distance between the legitimate devices' signatures is smaller compared to the distance between signatures of the legitimate and tampered board. As expected, by constraining the frequency 5 range, the distance between tampered versions of the boards and legitimate boards will increase, and for some tampering levels, it reaches the maximum inter-distance value (i.e., 50%).

Various embodiments of the invention have been described above. However, it should be appreciated that alternative embodiments are possible and that the invention is not limited to the specific embodiments described above.

What is claimed is:

1. A method for verifying whether a printed circuit board is authentic, comprising:
characterizing a power distribution network of a printed circuit board to produce a signature based upon a reflection response parameter; and
comparing the signature from said characterizing to a known signature based upon a reflection response parameter for a corresponding authentic printed circuit board to identify differences.

2. The method of claim 1, further comprising:
characterizing a power distribution network of the corresponding authentic printed circuit board to produce the known signature.

3. The method of claim 1, wherein said reflection response parameter comprises amplitude (|S₁₁|) and phase (∠S₁₁).

4. The method of claim 1, wherein said signature comprises S₁₁ data, and further comprising:
mathematically modeling the S₁₁ data.

5. The method of claim 4, wherein said mathematically modeling comprises using a Gaussian mixture model to process data collected from said characterizing.

4. A method for verifying whether a printed circuit board is authentic, comprising:
characterizing a power distribution network of a first printed circuit board to produce a first signature based upon a reflection response parameter;
characterizing a power distribution network of a second printed circuit board to produce a second signature based upon a reflection response parameter; and
determining a distance between the first signature and the second signature.

5. The method of claim 1, wherein said reflection response parameter comprises amplitude (|S₁₁|) and phase (∠S₁₁).

6. The method of claim 1, wherein said signature comprises S₁₁ data, and further comprising:
mathematically modeling the S₁₁ data.

7. The method of claim 6, wherein said mathematically modeling comprises using a Gaussian mixture model to process data collected from said characterizing.
